(19) United States
(12) Patent Application Publication
(10) Pub. No.: US 2013/0298788 A1
(43) Pub. Date: Nov. 14, 2013

(54) METHOD AND A MACHINE FOR DECORATING BOTTLES BY INDIRECT PAD PRINTING USING A SHELL

(71) Applicant: SGD S.A., Puteaux (FR)

(72) Inventors: Anne Paule Arduina LEMAIRE, Abbeville (FR); Nicolas Pierre Francois Devaux, Ault (FR); Christophe Wagner, Neuville Les Dieppe (FR)

(21) Appl. No.: 13/891,497

(22) Filed: May 10, 2013

(30) Foreign Application Priority Data
May 10, 2012 (FR) 1254280

(51) Int. Cl. B41F 17/00

(52) U.S. Cl. CPC B41F 17/001
USPC 101/35; 101/493

(57) ABSTRACT

A method of decorating by pad printing for applying a decorative pattern (2) on the wall (3) of a previously-shaped part (4) to be decorated, such as a glass bottle, including a preparation step a) during which a liquid marker substance (5) of any viscosity is deposited in the imprint (11, 111) of a pad-die (10, 110) that is marked by an indentation of shape that is substantially complementary to the shape of the existing wall (3) of the part (4) to be decorated, which substance may be an ink or an enamel, and then a marking step b) during which the pad-die (10, 110) is moved towards the part (4) so as to bring the wall (3) of the part into contact with the bottom of the imprint (11, 111), so as to deposit the decorative pattern (2) on the wall (3) by transferring the marking substance (5) from the imprint onto the wall for decorating and marking objects.

### CROSS REFERENCE RELATED APPLICATIONS

This application claims priority to French Application Serial No. 1254280 filed May 10, 2012, which is entirely incorporated herein by reference.

The present invention relates to the general field of methods and machines for printing, marking, and decorating for the purpose of applying a pattern or a mark of any kind on the wall of a previously-shaped part, and intended in particular for decorating bottles such as those used for containing cosmetic preparations, perfumes, or pharmaceutical preparations.

More particularly, the invention relates to a method of decorating by pad printing for applying a decorative pattern on the wall of a previously-shaped part to be decorated, such as a glass bottle.

The present invention also relates to a decorator machine that operates by pad printing, and to a pad-printing die.

The present invention also relates to a glass or plastics container, such as a bottle, presenting angular walls that are provided with decoration made up of ink or enamel deposited by a pad-printing method.

It has been known for a long time to apply writing or ornamental patterns in various colors on numerous types of parts and articles, and in particular on glass bottles that are to contain cosmetic preparations, or perfumes, for example.

In this respect, it is known in particular to use silkscreen printing methods or indeed pad-printing methods.

Known pad-printing methods generally make use of a pad, e.g. formed by a substantially egg-shaped resilient block made of rubber or of silicone, with the tip of the pad being pressed against an etched plate that has previously been coated in ink, after which said pad is pressed against the wall of the object that is to be marked.

Although such techniques make it possible to obtain results that are satisfactory on articles of shapes that are regular and simple, they nevertheless present certain limits that restrict their field of application.

Known pad-printing methods generally do not enable parts that present shapes that are irregular or angular to be decorated in accurate or reproducible manner, since such shapes remain inaccessible to the pad.

In addition, they may be unsuitable for making decoration that is fine and accurate, in particular when it is desired to decorate the edges in the form of ridges or grooves on the article in order to emphasize its outline. Because of the relatively approximate nature of the positioning of known pads as they approach an article, and because of the sometimes random nature of their local deformation, it can happen that known pad-printing methods tend to shift the ink deposits or to cause them to spread beside or beyond the intended edge.

That is why it is necessary to decorate bottles manually, in particular for applications that need to present good esthetic appearance, as applies in particular for perfume bottles. Naturally, that puts a significant limit on production rates and on the reproducibility of the method, and also increases the cost of fabrication.

Consequently, the objects given to the invention seek to remedy the above-mentioned drawbacks and to propose a novel method of decorating by pad printing, which method presents performance that is improved, in particular in terms of accuracy, reliability, versatility, speed, and reproducibility.

Another object of the invention is to propose a novel pad-printing method that is particularly simple to perform and that can be performed at reasonable cost.

Another object of the invention is to propose a novel pad-printing method that makes it possible to decorate in selective and accurate manner parts that present shapes that are complex, and in particular angular surfaces.

Another object of the invention is to propose a novel pad-printing method that enables at least some associated operations to be performed in hidden time, in particular cleaning, inking, or indeed maintenance.

Another object of the invention is to propose a novel pad-printing method in which ink is transferred in a manner that is particularly accurate, effective, fast, and economic in terms of ink.

Another object given to the invention seeks to propose a novel machine for decorating by pad printing that enables any pattern or writing to be applied in fine, accurate, fast, and reproducible manner on the wall of a part to be decorated, regardless of the shape of the wall.

Another object given to the invention seeks to propose a novel machine for decorating by pad printing in which the structure of the machine is particularly simple, robust, stable, and suitable for keeping fabrication costs under control.

Another object given to the invention seeks to propose a novel decorator machine enabling all or a portion of a part presenting walls with angular ridges or grooves that are usually not decorable to be decorated in a manner that is accurate and selective.

Another object given to the invention seeks to propose a novel decorator machine that makes it possible to use an accurately metered out quantity of marking substance, and more particularly of ink.

Another object given to the invention seeks to propose a novel machine for decorating by pad printing that presents great versatility and good modularity.

Another object given to the invention seeks to propose a novel machine for decorating by pad printing that requires maintenance that is limited and simplified.

Another object given to the invention seeks to propose a novel type of pad that presents improved performance, great flexibility, and that has maintenance requirements that are small in terms of equipment and time.

Finally, another object given to the invention seeks to provide a glass container presenting walls with angular ridges or grooves that have been pad-printed in a minimum of steps.

The objects given to the invention are achieved with the help of a method of decorating by pad printing for applying a decorative pattern on the wall of a previously-shaped part to be decorated, such as a glass bottle, said method being characterized in that it comprises a preparation step a) during which a liquid marker substance of any viscosity is deposited in the imprint of a pad-die that is marked by an indentation of shape that is substantially complementary to the shape of the existing wall of the part to be decorated, which substance may be an ink or an enamel, and then a marking step b) during which the pad-die is moved towards the part so as to bring the wall of the part into contact with the bottom of the imprint, so as to deposit the decorative pattern on said wall by transferring the marking substance from the imprint onto said wall.

The objects given to the invention are also achieved with the help of a decorator machine for decorating by pad printing by applying a decorative pattern on the wall of a previously-shaped part to be decorated, such as a glass bottle, said machine being characterized in that it comprises:
at least one pad-die that has an imprint, said imprint being marked as a hollow with a shape that is substantially complementary to the shape of the existing wall of the part to be decorated;
inking means that enable a liquid or powder marking substance to be deposited in said imprint, such as an ink or an enamel; and
application means designed to move the part and the pad-die towards each other until the wall of the part to be decorated comes into contact with the bottom of the imprint, so as to enable the marking substance to be transferred from said imprint to said wall, thereby depositing the decorative pattern thereon.

The objects given to the invention are achieved with the help of a pad-die for pad printing, the pad-die being characterized in that it includes an imprint marked as an indentation and presenting a surface with angular ridges or grooves for pressing against the wall of a part to be decorated that is of substantially complementary shape.

Finally, the objects given to the invention are also achieved with the help of a glass or plastics container such as a bottle presenting walls with angular ridges or grooves that are provided with decoration made up of ink or enamel deposited by a pad printing method, the container being characterized in that said decoration is constituted by a single layer of substantially constant thickness, presenting a mean value lying in the range 5 micrometers (μm) to 50 μm and constituting a zone of decoration that is uniform and homogeneous.

Other objects, characteristics, and advantages of the invention appear in greater detail on reading the following description and with the help of the accompanying drawings that are provided purely by way of non-limiting illustration, and in which:

FIGS. 1A and 1B are face views of a set of pad-dies for forming a marker shell used in a decorating method of the invention;

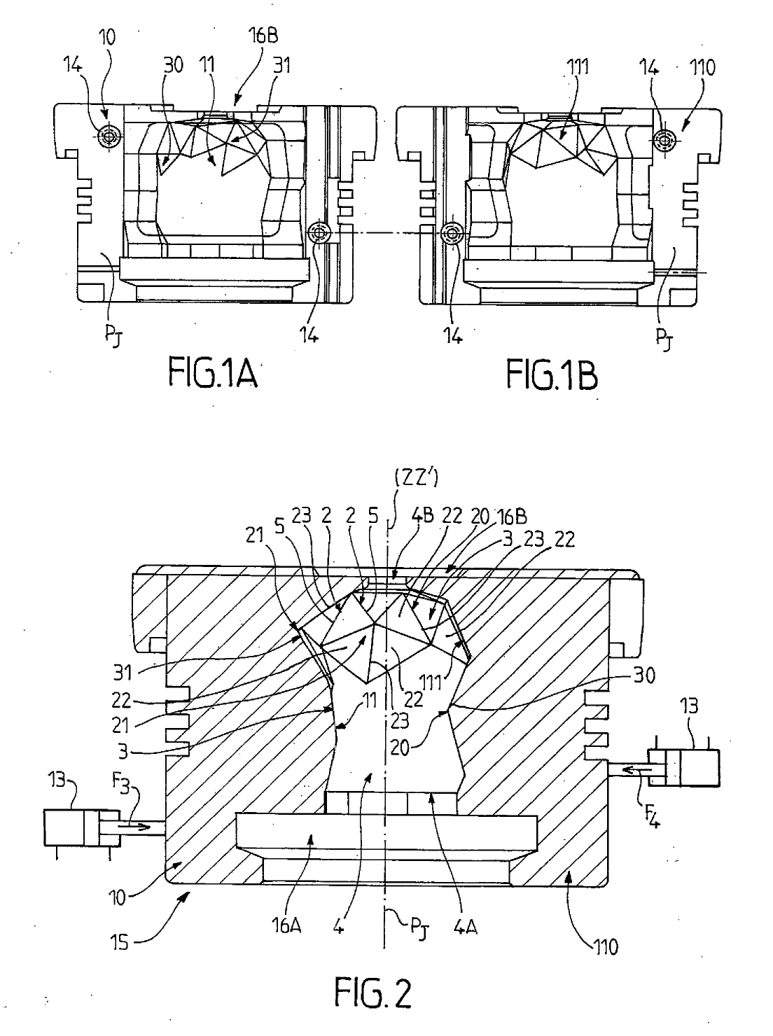

FIG. 2 is a side view of the FIG. 1 pad-dies closed on the part during the marking step of a method in accordance with the invention;

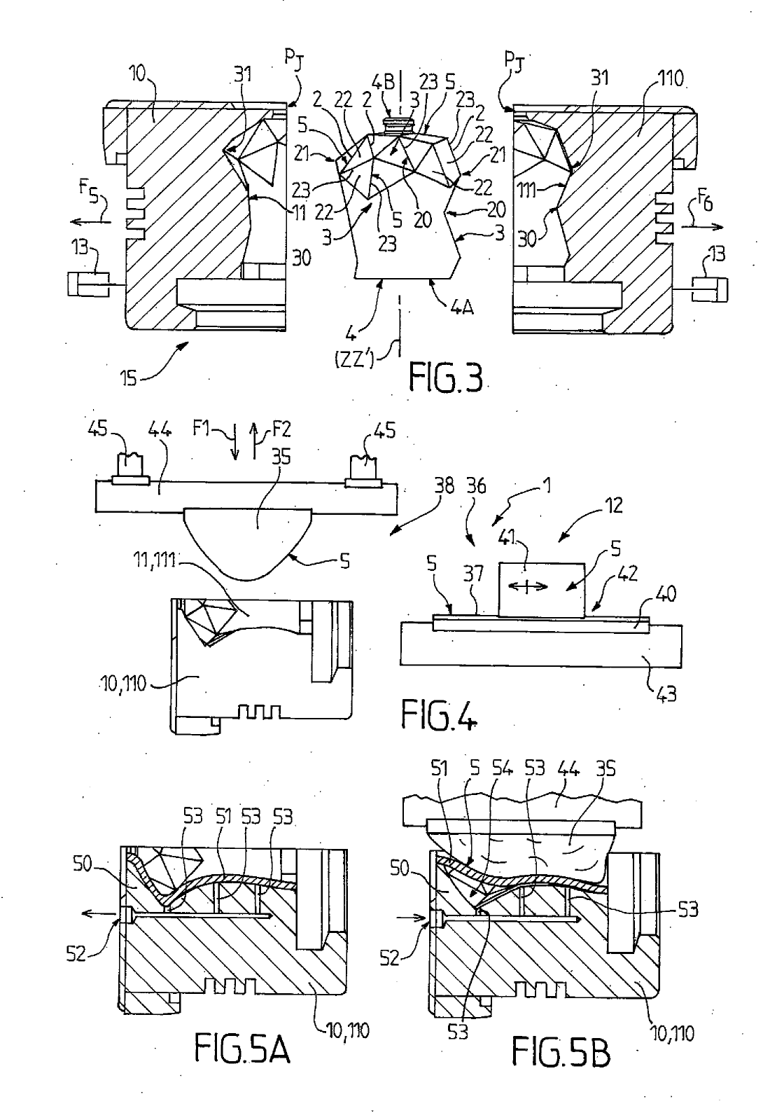

FIG. 3 is a side view showing the pad-dies being moved away and the part being released after it has been marked;

FIG. 4 is a diagrammatic view showing a portion of a decorator machine in accordance with the invention enabling the step of preparing a pad-die to be performed by means of an intermediate pad;

FIGS. 5A and 5B are diagrammatic side views showing the arrangement and the operation of a particular variant embodiment of a pad-die in accordance with the invention; and

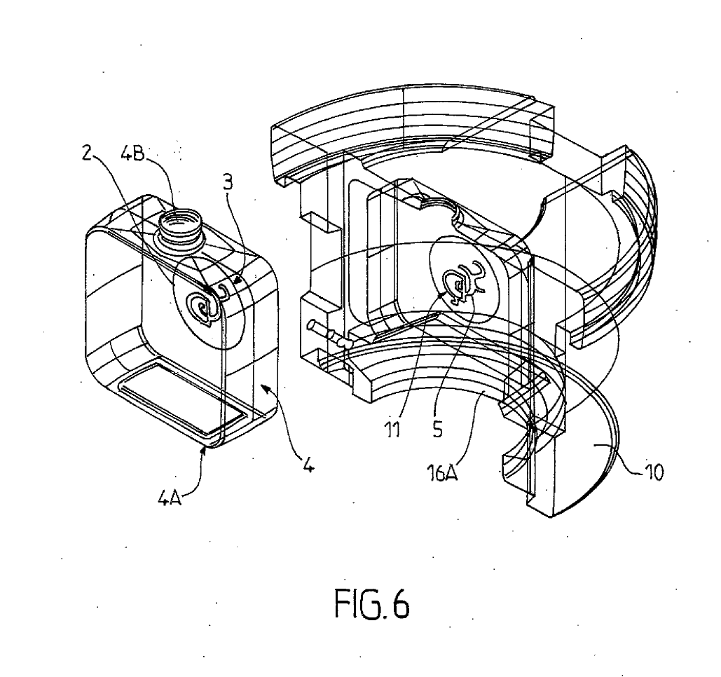

FIG. 6 is a 3D view of a pad-die and of a bottle in side view.

The present invention relates to a method of decorating by pad printing, and to a machine 1 for decorating by pad printing, each serving to convey a decorative pattern 2 onto the wall 3 of a part 4 to be decorated, said part already being shaped.

In the meaning of the invention, prior to being subjected to the decorating method and/or machine in accordance with the invention, the part 4 already presents its own shape, preferably corresponding to its finished, final, and substantially permanent appearance.

Naturally, said part 4 may be formed by any solid object that can be handled, regardless of its dimensions or the material from which it is made, providing it presents a wall 3 of surface that defines an outline with relief that is substantially determined.

In particularly preferred manner, said part 4 is constituted by a block or a container, in particular a bottle, preferably made of glass.

Naturally, the method and the machine could equally well be adapted to any type of container, regardless of the material from which it is made, and in particular to containers made of plastics material.

Naturally, the method and the machine in accordance with the invention may be adapted to apply any type of decorative pattern 2 without restriction, and in particular lines or patches of color, pictorial patterns of the logo or drawing type, alphanumeric characters, writing of any kind, fragments of text, etc.

The decorative pattern 2 is preferably for ornamental purposes, but it could equally well be used, like a label, for information, reference, traceability, advertising, or warning purposes.

In addition, the marking vector, i.e. the marking substance 5 that is used, is advantageously liquid, whatever its viscosity might be, and in particular it may be constituted by an ink or by an enamel.

Below, the method and the machine of the invention may be considered as being a method and a machine for decorating glass bottles by depositing inks by pad printing, without that constituting a limitation on the invention.

According to the invention, the machine 1 comprises:
at least one pad-die 10, 110 that has an imprint 11, 111, said imprint being marked as a hollow with a shape that is substantially complementary to the shape of the existing wall 3 of the part 4 to be decorated;
inking means 12 that enable a liquid or powder marking substance 5 to be deposited in said imprint 11, 111, such as an ink or an enamel; and
application means 13 designed to move the part 4 and the pad-die 10, 110 towards each other until the wall 3 of the part 4 to be decorated comes into contact with the bottom of the imprint 11, 111, so as to enable the marking substance 5 to be transferred from said imprint 11, 111 to said wall 3, thereby depositing the decorative pattern 2 thereon.

As described in greater detail below, the machine and the method in accordance with the invention advantageously enable decoration to be provided in accurate and reproducible manner on the part 4 by indirect pad printing, by fitting and in particular by housing said part 4 in an imprint 11, 111, preferably by laying it therein, the imprint forming a partial or total mold forming a negative of the wall 3 to be treated, said imprint 11, 111 having previously been impregnated or covered in the marking vector.

This makes it possible in particular to perform marking under conditions that are particularly stable, accurate, and reproducible, by using a quantity of marking substance 5 that is just necessary and sufficient for the operation, and applying said marking substance in a manner that is regular and substantially uniform over the entire zone that is to be treated and over only the zone that is to be treated, substantially without going beyond it.

The pattern 2 as transferred in this way onto the wall 3 of the part 4 is thus advantageously free of defects such as gaps, smudges, or running, and ignoring the mold joint line, in conventional manner.

The machine 1 preferably has at least a first pad-die 10 and a second pad-die 110, each having a respective imprint 11, 111 of shape that is substantially complementary to the shape of the wall 3 to be decorated, and more particularly to the respective portion of said wall 3 that corresponds thereto, as can be seen in particular in FIGS. 1A, 1B, 2, 3, and 6. This match is clearly visible in FIG. 6 which is a three-dimensional view.

Advantageously, the first and second pad-dies 10 and 110 are then designed to close against each other under the action of the application means 13 so as to hold the part 4 to be decorated captive between them, as shown in FIG. 2.

More particularly, the pad-dies 10 and 110 are advantageously capable of being moved and constrained in compression against each other along respective approach paths of substantially opposite and substantially converging directions F3 and F4 so as to enable them to act as a vice or jaws capable of exerting a clamping force on the part 4 during marking.

Advantageously, the part 4 can thus be held substantially stationary while being blocked and wedged against the bottom of one and/or the other of the imprints 11, 111, thereby presenting great stability during marking, thereby contributing to improving the quality, the accuracy, and the reproducibility of the marking.

The pad-dies 10 and 110 may advantageously be guided in their movement and their relative positioning, e.g. by an appropriate arrangement of the application means 13 on a common structure, and/or with the help of docking members, such as centering pegs 14 designed to align and center the first pad-die 10 relative to the second pad-die 110 as they close one against the other, preferably at the end of their stroke, immediately before said dies come completely into mutual contact.

In this respect, it should be observed that the first and second pad-dies 10 and 110 are preferably arranged so as to be capable of coming into contact one against the other in the closed position, said contact preferably taking place along a join plane P_{J} that preferably corresponds substantially to the midplane of the bottle 4 containing the generator axis (ZZ′) that passes substantially through the center of the bottom 4A of the bottle and through the center of the opening in its neck 4B.

Thus, the pad-dies may advantageously be united so as to form a substantially closed lateral outline around the part 4.

Furthermore, putting said pad-dies 10 and 110 into contact one against the other, preferably via their join plane, also makes it possible to create an end-of-stroke abutment that automatically and very reliably limits the clamping and compression force exerted by said pad-dies 10 and 110 on the part 4 during marking.

The method is thus particularly appropriate for mass decoration of parts that are particularly fragile, in particular glass bottles, and it enables zones to be decorated that usually cannot be decorated by conventional methods.

Naturally, the application means 13 may be arranged to move the part 4 itself relative to one and/or the other of the pad-dies 10 and 110, so as to be able to bring the part to at least one of the pad-dies, and preferably to deposit it in the corresponding imprint.

The application means may also be arranged to move one and/or the other of the pad-dies 10, 110 relative to the part 4, with the part then preferably remaining in a fixed position, and/or to move one of the pad-dies relative to the other.

The application means 13 may make use of any type of conveying or handling technology, and may in particular may comprise any type of conveyor, e.g. a conveyor belt, one or more actuators, rods, carriages, clamps, robot arms, etc. They may be driven by any suitable energy source, e.g. electrically, pneumatically, or hydraulically.

In a preferred embodiment, the closure movements F3, F4 for bringing the pad-dies 10 and 110 one against the other and the opening movements F5, F6 for moving the pad-dies apart from each other are performed by rectilinear movements in translation.

As shown in FIGS. 2 and 3, the two pad-dies 10 and 110 can then face each other, preferably in substantially symmetrical manner on either side of the midplane of the part 4, and more particularly the sagittal plane of the part, so as to be capable of alternating between pressing against each other for marking purposes (FIG. 2) and separating and moving away from each other so as to enable the marked part to be recovered and so as to enable them to be refilled with marking substance. This engagement needed by the invention can also be understood from FIG. 6.

In another variant embodiment (not shown), the pad-dies 10, 110 may be closed one against the other by performing rotary angular movements.

By way of example, said dies may then be hinged relative to each other so as to pivot along a common hinge edge running along the side of their join plane P_{J}.

Such angular closure may be performed in particular via the bottom of the bottle, the hinge edge then facing the bottom, or indeed relative to the side wall of the bottle, said hinge edge then being substantially parallel to the generator axis (ZZ′), for example.

Preferably, and as shown in FIG. 2, uniting the pad-dies 10 and 110 serves to reconstitute a shell 15 that covers most and preferably substantially all of the entire wall 3 of the part 4 to be decorated.

More particularly, the imprints 11 and 111 are preferably arranged, when they are juxtaposed, to act together to cover, and more particularly to make contact with, at least 50%, or at least 75%, or indeed at least 90% if not 100% of the outside surface of the wall 3 that defines the outside volume of the part 4 to be decorated.

Thus, when united, the pad-dies can reconstitute a kind of marking mold with the major part or even all of the part 4 being received therein during marking.

In addition, such an arrangement makes it possible to ensure that the part is held reliably, stably, and in balanced manner during marking, thereby improving marking quality.

Finally, the same arrangement advantageously makes it possible to perform marking treatment simultaneously on a plurality of zones of the part, and in particular on edges or faces that are far apart from one another, and possibly even opposite one another, and in particular that are situated on opposite sides of the generator axis (ZZ′) or the join plane P.

Advantageously, such simultaneous treatment of all of the zones to be decorated, with a plurality of distinct decorative patterns being applied, where appropriate, to a plurality of regions in three-dimensional space that are different and possibly even diametrically opposite, makes it possible to reduce cycle time and consequently to increase the production rate and the efficiency of the machine, and also of the method.

In particularly advantageous manner, it is remarkable that the invention also makes it possible to decorate a bottle simultaneously on all of its faces and/or its edges, without there being any need to perform decoration operations in separate and sequential manner face after face, possibly with the need to reposition the bottle between each of the marking stages, e.g. by turning it or tilting it.

In contrast, the present invention makes it possible to transfer ink from the machine onto the bottle in a single pass of closing the shell 15, while the bottle occupies a single position that it retains throughout the marking operation.

Where appropriate, and as shown in particular in FIG. 2, the shell 15 may have setbacks 16A, 16B preferably situated substantially facing the bottom 4A and the neck 4B of the bottle 4.

Nevertheless, said shell 15 is preferably arranged in such a manner that, when in the marking configuration, the part 4 is completely contained inside the outline defined by the overall volume of the united pad-dies 10 and 110, with no element of the part 4 projecting outside the shell 15.

The pad-dies 10 and 110 preferably form respective half-shells of size and shape that are preferably substantially equivalent, as shown in FIG. 2.

Nevertheless, it is possible to provide more than two, and in particular at least three, pad-dies so as to form a shell of a shape that is more complex, possibly also including one or more cores (not shown) so as to hold or decorate parts that present shapes that are particularly complex, and in particular parts that are very irregular or concave. Thus, depending on the configuration of the part to be decorated, the number of pad-dies is adapted so as to facilitate unmolding while preserving the visual quality of the deposit that is made.

Naturally, the pad-dies 10 and 110 may be made of any suitable material providing they present sufficient stiffness to conserve substantially the shapes of their respective imprints 11 and 111 and to withstand the closure and compression forces.

Said pad-dies 10 and 110 may preferably be made as solid metal blocks by machining, or indeed as blocks of polymer material, e.g. obtained by molding.

Where appropriate, and in a variant that is not shown, the pad-die(s) 10 and 110 may include firstly an outer support frame, e.g. in the form of a rectangular parallelepiped, with said frame having a housing for receiving an interchangeable insert of shape that determines the shape of the imprint 11, 111.

Thus, according to a characteristic that is capable of constituting an invention on its own, using a single set of basic support frames, it is possible to adapt the pad-dies 10, 110 to various types of part 4 merely by exchanging inserts, which inserts could also be removed and replaced, where necessary, in the event of becoming excessively worn.

The wall 3 of the part 4 to be decorated preferably includes at least one angular portion 20, 21, which portion may be a re-entrant portion or groove 20 or on the contrary a projecting portion or ridge 21, and it may present at least two intersecting faces 22 that are separated from each other by at least one edge 23.

In other words, the wall 3 preferably presents at least two faces 22 on its free surface, i.e. facing the outside, and preferably presents a plurality of substantially non-coplanar faces, each of which may equally well be plane or curved (indented or projecting), with the junction between the faces being made by edges that may be sharp or, on the contrary, may be rounded by fillets in order to soften the outlines of the part.

More generally, the angular portions 20, 21 may preferably present relief presenting a succession of surfaces that are convex and concave.

The imprint 11, 111 of the or each pad-die 10, 110 preferably then presents an angular surface 30, 31 constituting a negative that is to be engaged substantially on the angular portion 20, 21 of the wall 3.

Advantageously, each imprint 11, 111 may thus present a single piece having relief that is substantially complementary to the relief of the portion of the wall 3 that it is to cover.

For example, the imprint 11 may have at least one projecting portion 30 for penetrating into a re-entrant portion 20 of the part, substantially between two or more adjacent faces 22 forming a depression in the wall of the part, with this being in order to be capable of penetrating into said depression so as to come into contact with said faces 22 on either side of it and/or with the edge(s) 23 that mark the bottom of the depression.

Likewise, the imprint 11 may also have one or more indented portions for fitting over one or more projecting edges 23 of the part so as to press along said edge(s), forming a projecting ridge line on the wall of the part, and/or pressing against the faces, and in particular the starts of the faces 22 on either side of said edge.

Advantageously, the pad-dies 10, 110 in accordance with the invention are thus capable of fitting substantially closely over the outlines presenting the greatest difficulty of access on the part 4, in order to mark them cleanly, effectively, and accurately.

Advantageously, the machine and the method in accordance with the invention make it possible in particular to mark automatically and with a very low reject rate bottles of shapes that are very special, irregular, and rough, presenting varying curvatures and possibly even discontinuities forming abrupt breaks as for example bottles presenting a polyhedral wall with a plurality of intersecting facets 22 on the side portion of the wall 3 surrounding the generator axis (ZZ′).

The machine and the method in accordance with the invention also make it possible to act automatically to mark bottles of shapes that are simpler, such as a bottle 3 in the form of a rectangular parallelepiped, as shown in FIG. 6.

As shown in FIG. 4, the inking means 12 preferably comprise an intermediate pad 35 that is suitable for moving between an inking station 36 where said intermediate pad 35 is pressed against an etched plate 37 that carries the marking substance 5 in order to take that substance, and a transfer station 38 where it is pressed against the imprint 11, 111 of the pad-die 10, 110 in order to discharge thereon the marking substance 5 that it has taken.

The intermediate pad 35 may advantageously be in the form of a standard pad, and more particularly a flexible punch, e.g. made of rubber or of silicone, and preferably substantially egg-shaped with its base preferably mounted on moving equipment 44 so that its tip can plunge into the imprint 11, 111 when said moving equipment faces it, and in particular when it is thereabove.

Thus, according to a characteristic that is capable of constituting an invention on its own, the machine and the method in accordance with the invention preferably make use of two sets of pads, namely a first pad, specifically the intermediate pad 35 that is preferably of any shape, preferably generally convex and in particular of a standard egg-shape, and that makes it possible to use a supply of ink that is preferably associated with an etched plate 37 to refill a second pad, specifically a second set of pad-dies 10, 110 that are of shapes that are specific for matching the part 4 to be marked, and in particular that are of generally convex shape with a recess imprint of shape substantially complementary to the shape of the wall of said part 4. In the invention, the shape of the intermediate pad 35 may vary and it is specifically adapted to the shape of the part to be decorated.

The machine 1 in accordance with the invention consequently presents a highly modular nature, since it is possible to adapt it to any type of part, and in particular to any type of bottle 4, merely by replacing the pad-dies 10, 110.

As a result, it can be inexpensive to fabricate, since the components of the inking means 12 are preferably constituted by standard components, thereby greatly simplifying installation and maintenance of the machine.

In addition, the inking and refilling tasks of the intermediate pad 35, and also the task of marking the part 4 with the help of the pad-die 10, 110 may advantageously be performed simultaneously in separate manner but in hidden time, thereby enabling the throughput rate of the machine to be increased.

In addition, the use of an intermediate pad 35 advantageously makes it possible to take and make use of only that quantity of ink 5 that is necessary and sufficient for preparing the pad-dies 10, 110 and for marking the part 4, thereby enabling ink 5 to be saved.

Furthermore, the inking station 36 includes an etched plate support 40 for receiving the etched plate 37, and an inker 41 containing the marking substance 5, said inker 41 preferably being mounted on an inker carriage 42 that is suitable for moving along the etched plate support 40 in order to feed marking substance 5 to the etched plate 37. In a variant, the dynamic configuration may be inverted, with the inker 41 being stationary and the intermediate pad 35 being movable.

More particularly, the inker carriage 42 may have nozzles, ink rollers, or any other type of equivalent member enabling a film of ink to be deposited on the surface in relief of the etched plate 37 when the inker carriage 42 travels along the support 40.

In this context and preferably, the etched plate 37 is formed by a preferably metal plate in which the pattern 2 has been etched, preferably as a deformed projection in order to accommodate the radius of curvature and the roughnesses of the wall 3 on which it is subsequently to be transferred.

The inker carriage 42 can then be mounted to move in translation along said plate.

The plate support 40 may be fastened on a soleplate 43.

The movements necessary for the intermediate pad 35 to pass from the inking station 36 to the transfer station 38, and back again, may be implemented by any suitable means.

In particular, said means may be designed to form moving equipment 44 carrying the intermediate pad 35 and suitable exclusively for moving said intermediate pad 35 with all of the necessary degrees of freedom, while the soleplate 43, and the pad-die 10, 110 that is to be impregnated remain in a stationary position.

Alternatively, said means may be designed to move in alternation the soleplate 43 and the pad-dies 10, 110 in order to bring them up to the intermediate pad, and for this purpose, they may for example comprise conveyors or slides that place in alternation either the soleplate 43 carrying the etched plate 37, or else the pad-die 10, 110 so as to face the intermediate pad 35, and more particularly so as to be located under it.

Preferably, said movement means are distributed so that some of the degrees of freedom, and thus of the movements are performed by the soleplate 43 and the pad-dies 10, 110, while the others are performed by the moving equipment 44 and the intermediate pad 35.

In a preferred variant embodiment, and as shown in FIG. 4, said intermediate pad 35 is supported by moving equipment 44 driven by actuators 45, such as jacks, giving it at least one degree of freedom to move in controlled manner along an “application direction”, that is preferably substantially rectilinear and vertical, enabling it to approach F1 and be pressed against the etched plate 37, or against the imprint 11, 111, and then enabling it to be withdrawn F2, i.e. in this example enabling it to be lowered F1 and then to be raised F2.

In a variant embodiment, the moving equipment 44 may be formed by a boom having two or three axes, providing firstly a first degree of freedom enabling the intermediate pad 5 to move down into contact with the etched plate 37 or the imprint 11 in the application direction F1, F2, and also one or two degrees of freedom to move in transverse translation, preferably along two orthogonal directions forming a plane that is substantially normal to said application direction F1, F2, i.e. a plane that is substantially horizontal in FIG. 4.

Furthermore, according to a preferred characteristic that is capable of constituting an invention on its own, the pad-die 10, 110 may include at least one rigid anvil 50, as shown in FIGS. 5A and 5B, which anvil defines substantially the recessed functional shape of the imprint 11, 111, together with at least one flexible impregnation membrane 51 lining said anvil 50 so as to define the bottom of said imprint 11, 111.

Advantageously, such a design makes it possible in particular to interpose an impregnation membrane 51 that forms a kind of flexible damper-cushion between the bottom of the pad-die 10, 110, i.e. the rigid inside wall of the shell 15, and the wall 3 of the part 4 to be marked.

Advantageously, such an arrangement makes it possible to reconcile using a solid pad-die 10, 110 having an imprint 11, 111 that is rigid and substantially invariant, or indeed practically unalterable, with marking parts that may be relatively fragile, given that such a lined matrix acts in particularly gentle manner with the part being treated.

Furthermore, the impregnation membrane 51 may advantageously be fastened by reversible means enabling it to be removed, and enabling it in particular to be replaced in the event of it become worn or breaking, with said membrane 51 then acting as a sacrificial wear part that serves to confer a two-layer structure to the die, with the impregnation layer forming a kind of buffer that contributes to preserving the anvil 50 in the long term and more particularly to preserving the imprint 11, 111 defined therein.

According to another preferred characteristic, that is likewise itself capable of constituting an invention on its own, and regardless of the way the machine 1 is arranged and regardless of the shape and the arrangement of the pads that are used, etc., the machine 1 may be provided with inflation means 52 suitable for injecting a fluid under pressure, and in particular air or oil under pressure, between the anvil 50 and the impregnation membrane 51 in order to lift said impregnation membrane 51 off the bottom of the imprint, at least over a portion of their area in common, or indeed over most if not practically all of said area in common.

As shown in FIGS. 5A and 5B, the inflation means 52 may comprise one or more nozzles 53 advantageously fed by manifolds (not shown), the nozzles forming ducts that open out into the gap 54 at the interface between the bottom of the anvil 50 and the impregnation membrane 51.

Advantageously, it is thus possible at least temporarily to apply extra pressure enabling all or part of the impregnation membrane 51 to be separated and lifted, which membrane is preferably made as a single piece, with this having the effect of developing the profile and in particular its most re-entrant portions, thus making it easier for it to become impregnated by the intermediate pad 35, as shown in FIG. 5B.

Alternatively, by exhausting the inflation fluid, and more preferably by establishing suction in the gap 54, it is possible to return the impregnation membrane 51 and press it against the bottom of the anvil 50, as shown in FIG. 5A, so that said membrane 51 fits closely to the shape of the imprint 11, 111 and therefore takes on a shape that is appropriate for transferring the marking substance 5 from the pad-die onto the wall 3 of the part 4 to be marked.

The impregnation membrane 51 is preferably placed freely on the anvil so as to be capable of becoming detached from the bottom thereof, naturally with the exception of certain retention zones that serve to fasten and hold said membrane in position on the anvil.

Naturally, the present invention may relate to any member or to any subassembly of the above-described machine 1 as such.

In particular, the present invention also relates to a pad-die 10, 110 for pad printing and that includes an imprint 11, 111 forming an indentation, said imprint presenting an angular surface 20, 21 that is for pressing against the wall 3 of the part 4 to be decorated that is of substantially complementary shape.

Likewise, the present invention also relates as such either independently or in combination with the above-mentioned characteristic, to a pad-die 10, 110 that comprises a rigid anvil 50 substantially defining the functional indented shape of the imprint 11, 111, together with at least one flexible impregnation membrane 51 that lines the bottom of said anvil 50 so as to cover said imprint 11, 111.

The present invention also relates to a container, such as a bottle, made of glass or of plastics material and presenting angular walls that are provided with decoration made up of ink or enamel deposited by a pad printing method characterized in that said decoration is made up of a single layer of substantially constant thickness, with a mean value lying in the range 5 μm to 50 μm and constituting a decoration zone that is uniform and homogeneous. This zone in which the pattern is arranged thus does not include any overlap nor any unintended gap in the pattern that is reproduced.

There follows a description of a method in accordance with the invention for decorating by pad printing, the description being given with reference to a machine 1 as described above, and with reference to the accompanying figures.

In the invention, said method includes a preparation step a) during which a liquid marker substance 5 of any viscosity is deposited in the imprint 11, 111 of a pad-die 10, 110 that is marked by an indentation of shape that is substantially complementary to the shape of the existing wall 3 of the part 4 to be decorated, which substance may be an ink or an enamel, and then a marking step b) during which the pad-die 10, 110 is moved towards the part 4 so as to bring the wall 3 of the part into contact with the bottom of the imprint 11, 111, so as to deposit the decorative pattern 2 on said wall 3 by transferring the marking substance 5 from the imprint onto said wall.

Advantageously, the part 4 and the pad-die 10, 110 are initially spaced apart from each other in order to enable the imprint 11, 111 to be coated or impregnated with an appropriate quantity of a marking substance 5 that is deposited in the pattern 2 that is to be obtained, and then they are moved towards each other until they meet so as to allow the marking substance to be transferred by contact from the zones carrying said substance on the coated or impregnated surface of the imprint onto the outside surface of said wall 3.

Naturally, this moving together may be performed in various ways.

Thus, it is possible in particular to envisage taking the part 4, and more particularly the bottle, from a reception zone, such as a storage vessel, so as to place it, and in particular so as to lay it down in the housing formed by the imprint 11, 111, and then to exert additional pressure so as to force contact between the wall 3 and the bottom of the imprint 11.

The part 4 is then extracted from the imprint 11 after being marked.

Such an operation can be performed manually, by an operator, or it may preferably be performed automatically with the help of a conveyor, e.g. provided with actuator-operated ejectors or indeed with hinged robot arm means capable of taking hold of the bottle with a clamp and of transporting it to the pad-die.

Conversely, it is also possible to place the bottle 4 in a waiting position in a reception zone, in which it may optionally be clamped, e.g. by a jaw system or else by suction, and then to move the pad-die so as to press it against said bottle 4.

Preferably, during the marking step b), the part 4 to be decorated is simultaneously enclosed within a plurality of pad-dies 10, 110 each presenting an imprint 11, 111 of shape substantially complementary to a portion of the wall 3 of the part, each of said pad-dies being pressed in a distinct approach direction against the respective portion of the wall of the part corresponding thereto.

More particularly, it is possible to use two pad-dies for approaching each other in substantially opposite directions, and for sandwiching the part 4, as shown in FIGS. 2 and 3.

The closure movement F3, F4, and the opening movement F5, F6 may take place along paths that are substantially rectilinear and opposite, or on the contrary along paths that are angular, preferably about a common pivot axis, and in opposite directions.

In this context, in a variant implementation, it is possible during the marking step to begin by depositing, and in particular laying down, the part 4 in the imprint 11 of the first pad-die 10, which is itself substantially stationary, and then moving the second pad-die 110 towards the first so as to cover the still-uncovered portion of the part 4. Naturally, the application means 13 may be adapted accordingly, and they may be actuated completely or in part either manually or, preferably, automatically.

In particularly preferred manner, the approach movement F3, F4 of the pad-dies 10, 110 takes place in a direction that is substantially transverse, or indeed substantially normal to the side wall of the bottle 4, and more particularly to the generator axis (ZZ′) of the bottle.

Preferably, the marking step b) is performed by closing a shell 15 made up of a plurality of pad-dies 10, 110, and preferably of two pad-dies, onto the part 4 to be decorated, said shell covering most and preferably all of the entire outside wall of the part 4, thus leaving no portion of said part projecting out from the shell when the shell is closed and covers all of said part, as shown in FIG. 2.

In general, it is remarkable that the method in accordance with the invention acts in particularly gentle manner on the entire structure of the part 4 and preferably does not contribute in any way to shaping said part 4, serving to do no more than apply a decorative pattern on pre-existing shapes.

The juxtaposition between the pad-die 10 and the bottle 4 as shown in FIG. 6 enables the bottle 4 to be marked without being deteriorated.

Advantageously, this makes it possible firstly to avoid damaging the part 4, thus limiting the breakage and rejection rate.

Furthermore, in such a solution, the decoration-applying tooling, and in particular the pad-dies 10, 110, is subjected to mechanical, chemical, and/or thermal stresses well below those imposed on tooling for fabricating and shaping, thus enabling decoration-imparting tooling to be made that is less expensive, while also increasing the reliability and the lifetime of such tooling.

In particular, it is possible to envisage performing the method in accordance with the invention at low temperature, in particular at ambient temperature or at a temperature lying substantially in the range 5° C. to 45° C., with printing being performed at a pressure lying in the range 500 newtons (N) to 5000 N.

It is also possible to use a particularly wide range of marking substances 5, both in terms of composition and in terms of tint, insofar as the properties of such substance 5 are in no danger of being changed during marking, and in particular of being degraded by heat, and indeed some substances actually require being raised in temperature in order to be used.

The method of the invention is thus particularly adapted and suitable for decorating glass bottles that have previously been fabricated at very high temperature, and that can be decorated only separately, after they have cooled down and after fabrication quality has been inspected.

As shown in FIG. 3, the two half-shells formed by the pad-dies 10, 110 may initially be spaced apart from each other so that the shell 15 is wide open to allow the bottle 4 to be inserted.

They are then moved towards each other so as to become substantially molded over the outline of the bottle, as shown in FIG. 2, with the final approach advantageously being guided by the centering pegs 14 carried by one of the pad-dies and penetrating into corresponding holes formed for this purpose in the other die.

The approach movement F3, F4 continues until the pad-dies 10, 110 come into abutment against each other, establishing contact, preferably substantially plane contact, along their join plane P.

Advantageously, closure of the shell may be accompanied by the impregnation membrane 51 being compressed a little so that it flattens slightly under the pressure exerted by the shells, thereby facilitating the transfer of ink by being pressed homogeneously and substantially uniformly on the zones that are to be treated of the wall of the part.

Advantageously, the damping role of said impregnation membrane, and also the degree of centripetal radial compression exerted on the bottle 4, can be adjusted by making suitable selections for the thickness, the density, and the springiness of said membrane 51.

Advantageously, the shell 15 is kept closed for the length of time needed for transfer, for example for a duration that lies substantially in the range 0.1 seconds (s) to 10 s.

Preferably, the wall 3 of the part 4 possesses at least one re-entrant angular portion 20, or on the contrary at least one projecting angular portion 21, the angular portion presenting at least two intersecting faces 22 separated by at least one edge 23, and the marking step b) includes an engagement substep b1) during which a portion of the imprint 11, 111 of the pad-die is pressed against the angular portion of the wall 20, 21, which imprint portion presents angular relief 30, 31 as a negative that is substantially complementary to the relief of the angular portion 20, 21 of the wall of the part.

Advantageously, this matching between the portion in relief of the wall of the part and of the imprint 11, 111 makes it possible to treat all types of angular wall in simultaneous and clean manner, including angular walls that present very twisted portions in relief, constrictions, or indeed grooves, in particular a plurality of edges 23 that may be sharp or on the contrary rounded, and that are projecting and re-entrant in alternation, and/or oriented in directions that are very different from one another. Naturally, this matching also makes it possible to mark walls of shapes that are simpler than that shown in FIG. 6.

In particular preferred manner, and as shown in FIGS. 2 and 3, the method may be used mainly to decorate the edges of the part 4, and more particularly the edges of a bottle possessing a multitude of non-coplanar facets that form one or more polyhedra, possibly with an alternating plurality of projections and indentations. The pattern 2 may then constitute one or more lines of ink or enamel that emphasize a preselected number of edges of said bottle.

Said method may be specially adapted for decorating at least a plurality of predetermined edges that are distinct from one another and possibly situated on faces that are opposite about the generator axis (ZZ′) of the bottle, and possibly for decorating them alone.

In this respect, during the engagement substep b1), the negative 30, 31 of the imprint 11, 111 preferably fits over the edge 23 if it is a projecting edge, or conversely penetrates into said edge 23 if it is a re-entrant edge, thereby depositing the marking substance 5 on said edge.

Advantageously, it is thus possible to decorate, and in particular to emphasize, one or more edges simultaneously with a uniform deposit substantially over the entire length thereof and without any spreading or offsetting, it being possible for the adjacent faces to remain completely clean.

It is possible in particular to envisage performing marking simultaneously on most or indeed all of the edges of the bottle, thereby making it possible in a single pass to obtain an esthetic appearance that is homogeneous and that, in principle, does not require any subsequent reworking.

In a variant implementation, it is naturally possible to decorate the faces 22 in the same manner, regardless of whether they are substantially plane or curved, outwardly or inwardly, or indeed to apply a substantially uniform layer of ink on any portion in relief, including faces 22 and edges 23.

The method of the invention may also be used to decorate a bottle 4 that is in the shape of a rectangular parallelepiped. The bottle 4 and a single pad-die 10 are shown in FIG. 6 in a 3D view purely by way of non-limiting illustration. Such a view shows the way the shapes of those two parts match.

Once the ink has been transferred onto the part, the shell is opened by moving said pad-dies 10, 110 apart so as to uncover the part 4.

In order to do this, it is advantageous to perform the withdrawal operation F5, F6, and more particularly to pull the pad-dies 10, 110 apart from each other with the help of the application means 13, and in particular of double-acting actuators, as shown in FIG. 3.

Naturally, the imprint presents a shape with draft so as to enable the part 4 to be separated and extracted after it has been marked and the shell 15 has been opened, in other words to perform a kind of unmolding without catching, thereby avoiding deteriorating the pattern that has just been deposited.

Furthermore, the preparation step a) preferably includes an inking substep a1) of taking marking substance 5, and more particularly ink, from an etched plate 37, which plate has previously been impregnated with ink contained in a supply 41. The ink is taken by pressing an intermediate pad 35 against said etched plate 37, which intermediate pad is preferably flattened against said etched plate 37 in an application (an impregnation) direction F1 that is substantially normal to the inked surface of said etched plate 37.

Thereafter, the preparation step a) preferably includes a transport substep a2) during which the intermediate pad 35 is separated from the etched plate 37 by raising, F2, said pad in FIG. 4, so as to bring said intermediate pad 35 subsequently into register with the imprint 11, 111 of the pad-die 10, 110.

As mentioned above, this transfer may be performed, at least concerning the movement components that are transverse to the application path F1, F2, either by means specific to the moving equipment 44 supporting the intermediate pad 35, or else by moving the soleplate 43 carrying the etched plate 37 and the pad-dies 10, 110 to be coated, and more particularly by interchanging them under said intermediate pad 35.

The preparation step a) may then include a transfer substep a3) during which the intermediate pad 35 is pressed against the imprint 11, 111 of the pad-die 10, 110, and more particularly the pre-impregnated intermediate pad is flattened against the bottom of the imprint, or at least against the membrane 51 for lining the bottom of said imprint, in order to transfer said marking substance 5 taken by the intermediate pad 35 onto said imprint.

Advantageously, during this transfer step, the etched plate 37 may be refilled automatically in hidden time by moving the inker carriage 42 that sweeps over the surface of said etched plate 37 and deposits the ink 5 therein.

It is also remarkable that the method in accordance with the invention thus makes it possible to perform indirect pad printing in two stages, a first stage of negative printing with the pad-dies 10, 110 being coated, followed by a second stage of transferring the pattern from the pad-die onto the part 4. As a result, the pattern 2 is transferred twice, which makes it possible in particular to achieve good adjustment of the quantity of ink and of the resolution or fineness of the trace.

According to a preferred characteristic that is capable of constituting an invention on its own, the preparation step may include, prior to the transfer substep a3), an imprint development substep a4) during which the imprint is developed so as to attenuate temporarily and at least in part its relief, so that during the transfer substep a3), the intermediate pad 35 is pressed against the imprint while it is developed in this way, and then an imprint return substep a5) during which said imprint is returned, after the intermediate pad 35 has been disengaged and before the pad-die is pressed against the part 4 to be decorated, so as to confer on said imprint its functional shape and relief that are substantially complementary to the shape and relief of the wall 3 to be decorated.

In other words, advantageously and as shown in FIG. 5B, it is possible to inject a fluid under pressure into the gap 54 that is preferably substantially leaktight and that is defined between the bottom of the anvil 50 and the surface of the impregnation membrane 51 opposite from its inked surface that is to come into contact with the part 4 so as to separate and flatten or deploy or smooth said membrane by tensioning it so as to make its smallest corners more accessible and thus facilitate transferring ink from the intermediate pad into said membrane 51.

Where appropriate, it is even possible to envisage inflating said membrane so that it takes on a generally convex outline of curvature that is substantially opposite to the concave profile of the functional imprint, and more particularly of the bottom of the anvil 50.

Advantageously, this stage of temporarily reconfiguring the imprint makes it easier to ink, so inking takes place with greater accuracy and more cleanly, and also with better uniformity than it would if the transferred ink were to accumulate in indentations that are too marked or on the contrary were to run away from edges that project too much.

In practice, with the rigid anvil 50 substantially defining the functional indented shape of the imprint 11, 111, and with said anvil being lined by the impregnation membrane 51 that is designed to come into contact with the surface of the anvil and to match its shape substantially, the imprint development substep a4) is preferably performed by injecting a fluid under pressure, in this example via one or more nozzles 53, into the separation gap 54 between said anvil 50 and the impregnation membrane 51 so as to separate the membrane from the bottom of the imprint.

In contrast, the imprint return substep a5) may be performed by returning the membrane 51 against the anvil 50 by exhausting or indeed establishing suction in said separation gap 54, thereby enabling the membrane 51 to be pressed intimately against the bottom of the imprint while marking is taking place, and then while the shell 15 is being reopened and the decorated part is being “unmolded”.

Naturally, the injection pressure of the inflation fluid, water, air, or some other fluid, needs to be sufficient to maintain the impregnation membrane 51 substantially inflated while it is receiving the intermediate pad 35 so as to limit any sagging of said membrane while the pad-die is being re-inked.

Thus, the decorating method and machine in accordance with the invention makes it possible to decorate parts of all kinds, and more particularly glass bottles, in a manner that is automatic, fast, and with good accuracy and excellent reproducibility.

In particular, the method and the machine make it possible to apply patterns and in particular one or more films of ink simultaneously in zones that used previously to be completely inaccessible, other than by applying them one by one, by hand or by using precision instruments.

The method and the machine in accordance with the invention thus provide a substantial improvement in productivity, by limiting breakage and rejection rates, and by increasing production rates, which rates can thus be the same as the rates at which the parts are fabricated, thereby avoiding the creation of a bottleneck in a production line.

The method and the machine are also particularly economic in terms of ink consumption, and they enable patterns that are homogeneous to be made in reproducible manner in particular from one edge to another and/or from one bottle to another, both in terms of composition and in terms of geometrical characteristics, and in particular in terms of thickness.

Furthermore, the associated tooling is particularly durable, easy to maintain, and easy to replace, should that be necessary.

Furthermore, the method and the machine in accordance with the invention make it possible to provide decoration installations and workstations that are particularly versatile, and that can easily be reconfigured from one series of bottles to another, with only a minimum number of members needing to be replaced, and in general only the etched plate 37 and the pad-dies 10, 110.

1. A method of decorating by pad printing for applying a decorative pattern (2) on the wall (3) of a previously-shaped part (4) to be decorated, such as a glass bottle, said method comprising a preparation step a) during which a liquid marker substance (5) of any viscosity is deposited in the imprint (11, 111) of a pad-die (10, 110) that is marked by an indentation of shape that is substantially complementary to the shape of the existing wall (3) of the part (4) to be decorated, which substance may be an ink or an enamel, and then a marking step b) during which the pad-die (10, 110) is moved towards the part (4) so as to bring the wall (3) of the part into contact with the bottom of the imprint (11, 111), so as to deposit the decorative pattern (2) on said wall (3) by transferring the marking substance (5) from the imprint onto said wall.

2. A method according to claim 1, in which, during the marking step b), the part (4) to be decorated is simultaneously enclosed within a plurality of pad-dies (10, 110) each presenting an imprint (11, 111) of shape substantially complementary to a portion of the wall (3) of the part, each of said pad-dies being pressed in a distinct approach direction against the respective portion of the wall of the part corresponding thereto.

3. A method according to claim 2, in which the marking step b) is performed by closing a shell 15 on the part (4) to be decorated, the shell (15) being made up of a plurality of pad-dies (10, 110) and covering most and preferably all of the entire outside wall (3) of said part (4).

4. A method according to claim 1, in which the wall (3) of the part to be decorated possesses at least one angular portion that may be a re-entrant portion (20) or on the contrary a projecting portion (21), having at least two intersecting faces (22) that are separated by at least one edge (23), and the marking step b) includes an engagement substep b1) during which a portion of the imprint of the pad-die is pressed against the angular portion (20, 21) of the wall of the part, which portion of the print presents a negative angular portion in relief (30, 31) that is substantially complementary to the angular portion in relief (20, 21) of the wall of the part.

5. A method according to claim 4, in which, during the engagement substep b1), the negative (30, 31) of the imprint (11, 111) fits over the edge (23) if it is a projecting edge, or penetrates into said edge (23) if it is a re-entrant edge, so as to deposit the marking substance (5) on said edge.

6. A method according to claim 1, in which the preparation step a) includes an inking substep a1) of taking the marking substance (5), during which substep the marking substance is taken from an etched plate (37) by pressing an intermediate pad (35) thereagainst, followed by a transport substep a2) during which the intermediate pad is separated from the etched plate and placed in register with the imprint (11, 111) of the pad-die (10, 110), followed by a transfer substep a3) during which the intermediate pad (35) is pressed against the imprint (11, 111) of the pad-die so as to transfer thereto the marking substance (5) taken by said intermediate pad.

7. A method according to claim 6, in which, prior to the transfer substep a3), the preparation step includes an imprint development substep a4) during which the imprint (11, 111) is developed so as to attenuate temporarily and at least in part its relief, so that during the transfer substep a3), the intermediate pad (35) is pressed against the imprint while it is developed in this way, and then an imprint return substep a5) during which said imprint is returned, after the intermediate pad (35) has been disengaged and before the pad-die (10, 110) is pressed against the part (4) to be decorated, so as to confer on said imprint its functional shape and relief that are substantially complementary to the shape and relief of the wall (3) to be decorated.

8. A method according to claim 7, in which, for the pad-die comprising a rigid anvil (50) substantially defining the functional indented shape of the imprint (11, 111), and for said anvil being lined by a flexible impregnation membrane (51) that is designed to come into contact with the surface of the anvil and to match its shape substantially, the imprint development substep a4) is performed by injecting a fluid under pressure into the separating gap (54) between the anvil (50) and the impregnation membrane (51) so as to separate the membrane from the bottom of the imprint, and in that the imprint return substep a5) is performed by returning the impregnation membrane (51) against the anvil (50) by exhausting or establishing suction in the separation gap (54).

9. A method according to claim 1 in which the method constitutes a method for decorating glass bottles.

10. A decorator machine (1) for decorating by pad printing by applying a decorative pattern (2) on the wall (3) of a previously-shaped part (4) to be decorated, such as a glass bottle, said machine comprising:
at least one pad-die (10, 110) that has an imprint (11, 111), said imprint being marked as a hollow with a shape that is substantially complementary to the shape of the existing wall (3) of the part (4) to be decorated;
inking means (12) that enable a liquid or powder marking substance (5) to be deposited in said imprint (11, 111), such as an ink or an enamel; and
application means (13) designed to move the part (4) and the pad-die (10, 110) towards each other until the wall (3) of the part to be decorated comes into contact with the bottom of the imprint (11, 111), so as to enable the marking substance (5) to be transferred from said imprint (11, 111) to said wall (3), thereby depositing the decorative pattern (2) thereon.

11. A decorator machine according to claim 10, and including at least a first pad-die (10) and a second pad-die (110), each presenting an imprint (11, 111) of shape substantially complementary to the shape of the wall to be decorated and designed to be closed one against the other under the action of application means (13) with the part to be decorated being held captive between them.

12. A decorator machine according to claim 11, in which, together the pad-dies (10, 110) constitute a shell (15) that covers most and preferably all of the entire wall (3) of the part (4) to be decorated.

13. A decorator machine according to claim 10 in which the wall of the part to be decorated includes at least one angular portion that may be a re-entrant portion (20) or on the contrary a projection portion (21), which portion presents at least two intersecting faces (22) that are separated by at least one edge (23), and the imprint (11, 111) of the pad-die presents a negative angular surface (30, 31) for engaging substantially with the angular portion (20, 21) of the wall.

14. A decorator machine according to claim 10 in which said inking means (12) include an intermediate pad (35) and an inking station (36), and said pad (35) is suitable for moving between said inking station (36) where it is pressed against an etched plate (37) carrying the marking substance (5) in order to take said substance, and a transfer station (38) where said pad is pressed against the imprint (11, 111) of the pad-die (10, 110) in order to discharge thereon at least a portion of the marking substance (5) it has taken.

15. A decorator machine according to claim 14, in which said inking station (36) has an etched plate support (40) for receiving an etched plate (37), an inker (41) that contains the marking substance (5) and that is mounted on a inker carriage (42) suitable for moving along the etched plate support (40) in order to feed marking substance (5) to the etched plate.

16. A decorator machine according to claim 10 in which the pad-die (10, 110) comprises at least one rigid anvil (50) substantially defining the indented functional shape of the imprint (11, 111), together with at least one flexible impregnation membrane (51) that lines said anvil in order to define the bottom of said imprint.

17. A decorator machine according to claim 16, in which said machine is provided with inflation means (52) suitable for injecting a fluid under pressure between the anvil (50) and the impregnation membrane (51) in order to separate the membrane from the bottom of the imprint.

18. A pad-die (10, 110) for pad printing, the pad-die comprising an imprint (11, 111) marked as an indentation and presenting a surface (20, 21) with angular ridges or grooves for pressing against the wall (3) of a part (4) to be decorated that is of substantially complementary shape.

19. A pad-die according to claim 18, and including a rigid anvil (50) substantially defining the indented functional shape of the imprint (11, 111), together with at least one flexible impregnation membrane (51) that lines the bottom of said anvil in order to coat said imprint.

20. (canceled)

21. A decorator machine according to claim 10 in which said marking substance is deposited in a single layer of substantially constant thickness, presenting a mean value lying in the range 5 μm to 50 μm and constituting a zone of decoration that is uniform and homogeneous.
